(19) United States
(12) Patent Application Publication
(10) Pub. No.: US 2020/0346630 A1
(43) Pub. Date: Nov. 5, 2020

(54) COMPACT WIND TUNNEL FOR FLIGHT AND HOVER CAPABILITIES

(71) Applicant: Azriel Caleb Outlaw, Hartford, CT (US)

(72) Inventor: Azriel Caleb Outlaw, Hartford, CT (US)

(21) Appl. No.: 16/399,071

(22) Filed: Apr. 30, 2019

(51) Int. Cl. B60V 1/06; B60V 3/00; B60V 1/02

(52) U.S. Cl. CPC B60V 1/06; B60V 1/02; B60V 3/00

(57) ABSTRACT

A compact lift generating system is provided. The lift generating system embodies a wind tunnel enclosure extending between an inlet and an outlet. An airflow generator may be fluidly coupled to the enclosure inlet, an intake of a feedback conduit may be fluidly associated with the enclosure outlet, and an airfoil disposed therebetween. Airflow is urged to engage the airfoil, producing lift. The airflow generator may include a fan, an amplifier and an air knife fluidly coupled in series, wherein an output end of the feedback conduit fluidly connects between the airflow generator and the amplifier. A plurality of wind tunnels enclosures may be operatively associated in series. A plurality of airfoils may be provided in a stacked orientation in one wind tunnel enclosure.

### BACKGROUND OF THE INVENTION

The present invention relates to hovercrafts, and more particularly, to a compact wind tunnel for flight and hover capabilities.

Current methods of achieving vertical lift and hovering are noisy, expensive and inefficient. Other aircraft require a runway for a vehicle to achieve lift, and so changes in air current disrupt flight operation. Additionally, current flight technologies are difficult to scale down for small personal flying vehicles. Specifically, the current systems perform poorly because their airfoils must be sufficiently long, requiring a wide area to generate lift. These systems also use a lot of energy, thereby demanding a lot of space onboard the vehicle to store fuel. Moreover, current approaches are complex and therefore take more time and money to manufacture.

As can be seen, there is a need for a compact, energy efficient hovercraft system embodying a compact wind tunnel for flight and hover capabilities. The hovercraft device of the present invention uses a compact airfoil and wind tunnel for reducing noise associated with rotors and turbines, which also saves fuel by minimizing operational space. As a result, the present invention grants vertical lift, landing and hovering capabilities for fixed wing or even no wing vehicles without the need for current rotating blades or vectored thrust methods. Furthermore, the components are easy to make or buy and are relatively inexpensive. It also requires less energy to achieve lift.

### SUMMARY OF THE INVENTION

In one aspect of the present invention, a lift generating system including the following: an enclosure extending between an inlet and an outlet; an airflow generator fluidly coupled to the inlet, wherein the airflow generator is external relative to the enclosure; an intake of a feedback conduit fluidly coupled to the outlet; an output of the feedback conduit fluidly coupled between the airflow generator and the inlet; and an airfoil disposed between the inlet and the outlet, whereby the airfoil operatively associates with an airflow urged through the inlet by the airflow generator to provide lift.

In another aspect of the present invention, a lift generating system includes an enclosure extending between an inlet and an outlet; an airflow generator fluidly coupled to the inlet, wherein the airflow generator is external relative to the enclosure; an intake of a feedback conduit fluidly coupled to the outlet; an output of the feedback conduit fluidly coupled between the airflow generator and the inlet; an airfoil disposed between the inlet and the outlet; an amplifier operatively associated between the airflow generator and the inlet, wherein the output of the feedback conduit is connected in series between the amplifier and the airflow generator; one or more air compressors and one or more air tanks operatively associated with the amplifier; a central processing unit electrically coupled to a power source, the one or more external compressed air tanks and air compressors, and the airflow generator via one or more power and data lines; a central processing unit electrically coupled to a power source, the one or more external compressed air tanks and air compressors, and the airflow generator via one or more power and data lines, wherein the central processing unit is configured to selectively control the airflow generator and/or the one or more external compressed air tanks and the air compressors; and an air knife operatively associated to the inlet, wherein the air knife is located in the enclosure, wherein the central processing unit is configured to selectively control the airflow generator and/or the one or more external compressed air tanks and the air compressors, whereby the airfoil operatively associates with an airflow urged through the inlet by the airflow generator to provide lift.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section detail view of an exemplary embodiment of the present invention, taken along line 2-2 of FIG. 1;

FIG. 3 is a section view of an exemplary embodiment of the present invention;

FIG. 4 is a section view of an exemplary embodiment of the present invention, taken along line 4-4 of FIG. 3;

FIG. 5 is a section view of an exemplary embodiment of the present invention, taken along line 5-5 of FIG. 3;

FIG. 6 is a side schematic view of an exemplary embodiment of the present invention;

FIG. 7 is a side section view of an exemplary embodiment of the present invention; and

FIG. 8 is a side section view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a compact lift generating system. The lift generating system embodies a wind tunnel enclosure extending between an inlet and an outlet. An airflow generator may be fluidly coupled to the enclosure inlet, an intake of a feedback conduit may be fluidly associated with the enclosure outlet, and an airfoil disposed therebetween. Airflow is urged to engage the airfoil, producing lift. The airflow generator may include a fan, an amplifier and an air knife fluidly coupled in series, wherein an output end of the feedback conduit fluidly connects between the airflow generator and the amplifier. A plurality of wind tunnels enclosures may be operatively associated in series. A plurality of airfoils may be provided in a stacked orientation in one wind tunnel enclosure.

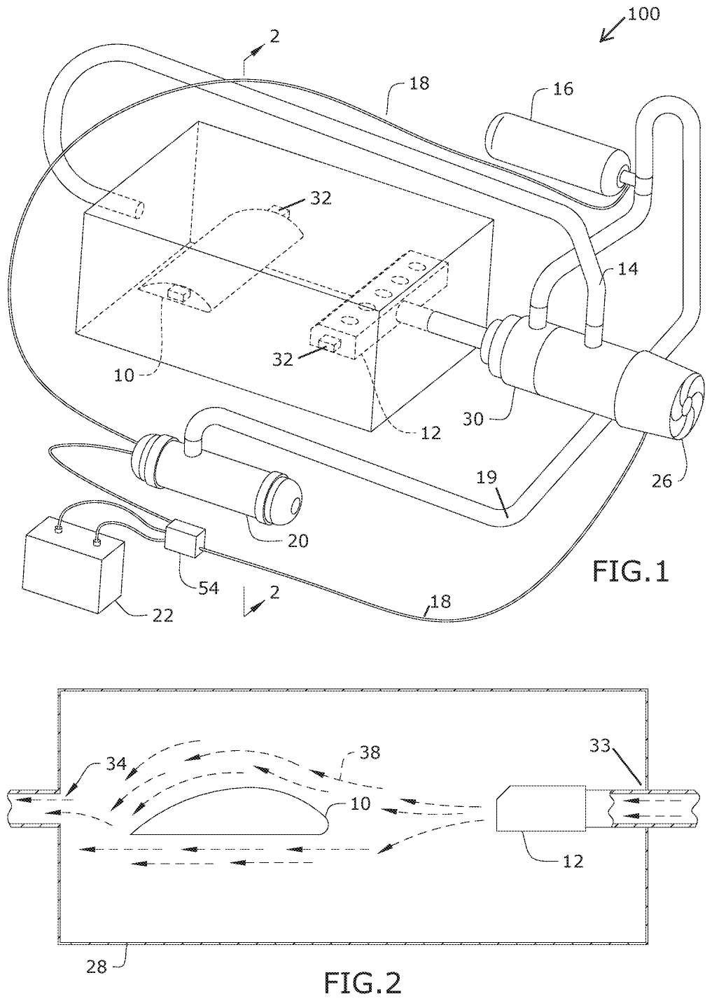

Referring now to FIGS. 1 through 8, the present invention may provide a lift generating system 100. The hovercraft system 100 may embody an enclosure 28 housing one or more airfoils 10 and an operatively associated airflow generator outlet(s) 12. Each airfoil is aligned with an airflow generator outlet 12 “in series” with and disposed between an enclosure inlet 33 and an enclosure outlet 34. The enclosure 28 may in effect be a wind tunnel. The airfoils 10 the airflow generator outlet(s) 12 may be connected between opposing walls of the enclosure 28 via opposing wall mounts 32. Each airflow generator outlet 12 may be an air knife operatively associated with an airflow generator 26 generating a resulting airflow 38.

The airflow 38 may be amplified by an amplifier 30 fluidly coupled to, in certain embodiments, a tail end of the airflow generator 26. The outlet of the amplifier 30 may be fluidly coupled with said enclosure inlet 33 and operatively associated with the air knife 12.

Additionally, a feedback conduit 14 may fluidly connect said enclosure outlet 34 and an intake of the amplifier 30, which in certain embodiments is connected in series between the outlet of the amplifier 30 and airflow generator 26.

The amplifier 30 may be operatively associated with one or more external compressed air tanks 16, one or more external air compressors 20, and an external electronic pressure gauge (not shown) via a compression conduit 19.

The lift generating system 100 may further include a central processing unit (CPU) 54 electrically coupled to a power source, the one or more external compressed air tanks 16 and air compressors 20, and the airflow generator 26 via power and data lines 18. The CPU 54 may be programmable to selectively control the airflow generator 26 and/or the one or more external compressed air tanks 16 and the air compressors 20.

FIG. 2 illustrates a section view of line 2-2 of FIG. 1, showing the enclosure 28 and the enclosure outlet 34 wherein the airflow 38 through the air knife 12 operatively associated with the serially aligned airfoil 10.

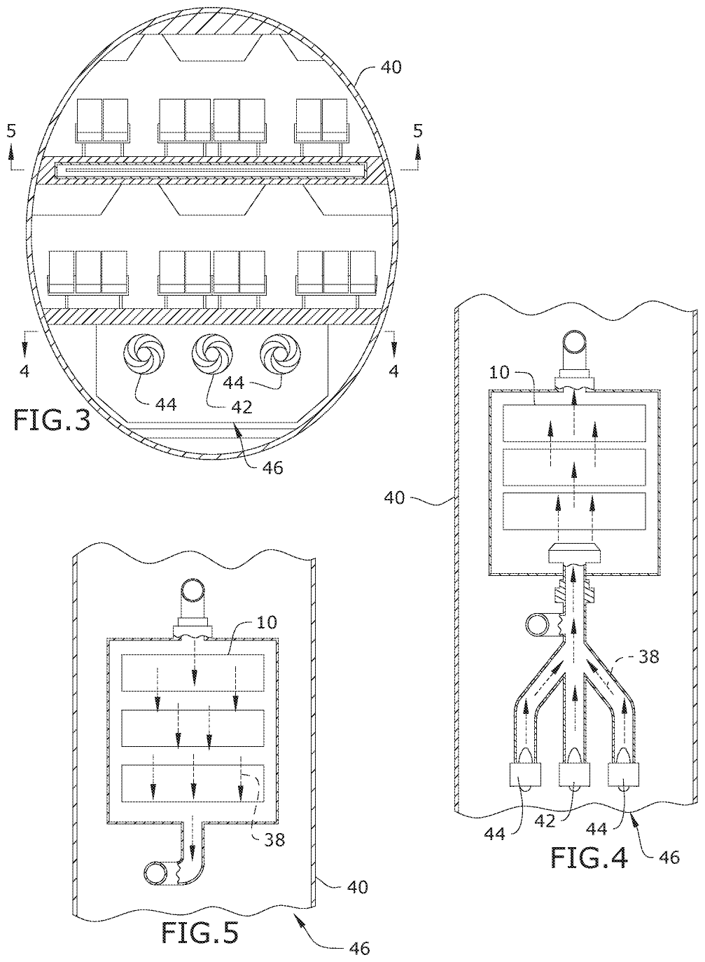

FIG. 3 shows an alternative embodiment of the present invention showing an airplane fuselage 40. Here, the lift generating system 100 includes a primary fan 42 and secondary redundant fans 44, each redundant fan 44 spaced apart on opposing sides of the primary fan 42. The lift generating system 100 may include an external wind tunnel 46 mounted, for example, below a floor of an upper deck of the fuselage 40. FIG. 4 is a section detail view of the lift generating system 100 taking along line 4-4 of FIG. 1; FIG. 5 is a section detail view of the system 100 taken along line 5-5 of FIG. 3.

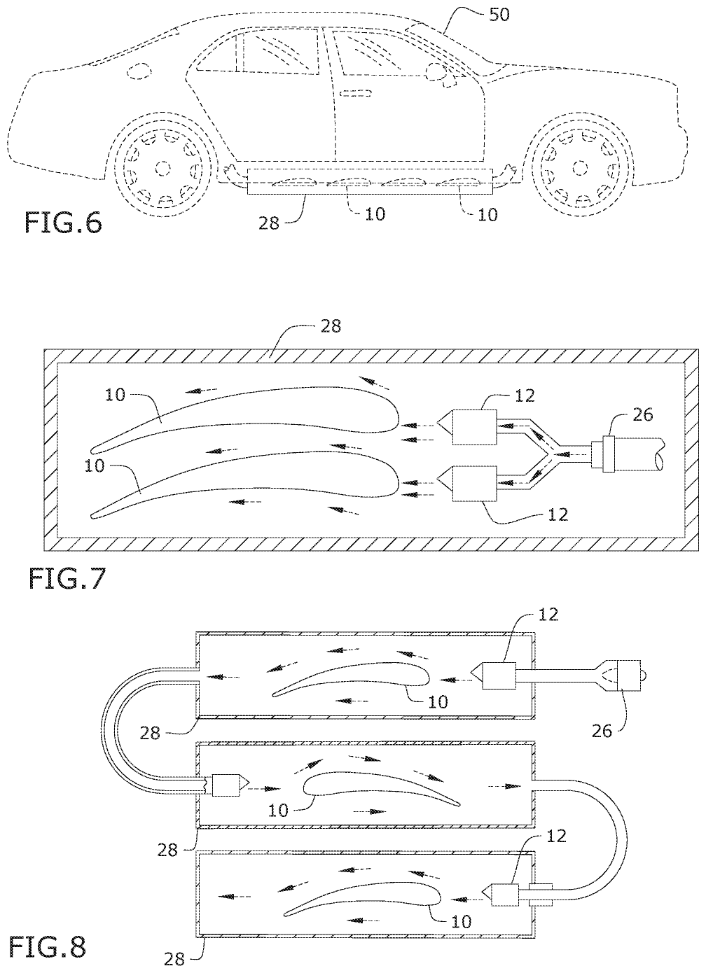

FIG. 6 shows an alternative embodiment of the compact hovercraft system 100 as mounted to a vehicle 50, wherein the compact lift generating system 100 can be used to vertically lift the vehicle 50.

An alternative embodiment of a side view of the compact lift generating system 100 is shown in FIG. 7, wherein the enclosure 28 includes two airfoils 10 and two air knives 12 attached to one airflow generator 26, wherein the two airfoils 10 and the air knives 12 are in a stacked orientation. FIG. 8 shows an alternative embodiment, wherein a plurality of enclosures 28 are mounted and connected to work together in series. It is to be understood that multiple enclosures 28 can be operatively associated to work together when needed.

In operation, the airflow generator 26 urges airflow 38 through the amplifier 30, which increases the velocity thereof through the air knife 12, wherein the velocity is further increased and expelled as an airflow sheet that flows across the airfoil 10, thus generating lift. The airflow 38 then flows through the feedback conduit 14 via the enclosure outlet 34 returning between the airflow generator 26 and the amplifier 30. The one or more external compressed air tanks 16 and air compressor may be operatively associated to power the amplifier 30, wherein the air compressor 20 refills the one or more compressed air tank 16 when they run low or empty. The one or more enclosures 28 hold and restrict the movement of the components.

The CPU 54 controls airflow generator 26 start/stop/speed, the air compressor 20 start/stop, and monitors and records flight data such as altitude and acceleration. For instance, when the compressed air tanks 16 powering the amplifier 30 runs low the CPU 54 may be adapted to check if the one or more compressed air tanks 16 need to be refilled and then signal the air compressor 20 to refill the compressed air tanks 16.

Advantageously, the compact lift generating system 100 allows modification of an existing vehicle 50, such as a small automobile to hover and fly by placing a series of these units in the engine bay, trunk, and/or undercarriage. A propulsion device like a propeller or jet turbine may be added. In another embodiment, the compact lift generating system 100 can also be incorporated in the body of commercial jets to give them vertical takeoff and landing ability, eliminating the need for runways.

It should be understood, of course, that the foregoing relates to exemplary embodiments of the invention and that modifications may be made without departing from the spirit and scope of the invention as set forth in the following claims.

What is claimed is:

1. A lift generating system, comprising:
an enclosure extending between an inlet and an outlet;
an airflow generator fluidly coupled to the inlet, wherein the airflow generator is external relative to the enclosure;
an intake of a feedback conduit fluidly coupled to the outlet;
an output of the feedback conduit fluidly coupled between the airflow generator and the inlet; and
an airfoil disposed between the inlet and the outlet,
whereby the airfoil operatively associates with an airflow urged through the inlet by the airflow generator to provide lift.

2. The lift generating system of claim 1, further comprising:
an amplifier operatively associated between the airflow generator and the inlet, wherein the output of the feedback conduit is connected in series between the amplifier and the airflow generator.

3. The lift generating system of claim 2, further comprising:
one or more air compressors and one or more air tanks operatively associated with the amplifier.

4. The lift generating system of claim 3, further comprising:
a central processing unit electrically coupled to a power source, the one or more external compressed air tanks and air compressors, and the airflow generator via one or more power and data lines,
wherein the central processing unit is configured to selectively control the airflow generator and/or the one or more external compressed air tanks and the air compressors.

5. The lift generating system of claim 1, further comprising:
an air knife operatively associated to the inlet, wherein the air knife is located in the enclosure.

6. The lift generating system of claim 4, further comprising:
an air knife operatively associated to the inlet, wherein the air knife is located in the enclosure.

7. The lift generating system of claim 1, further comprising:
a second enclosure of claim 1 operatively associated in series with the enclosure of claim 1, wherein the feedback conduit fluidly associates with the inlet of the second enclosure.

8. The lift generating system of claim 6, further comprising:
a second airfoil provided in the enclosure, wherein the second airfoil is spaced apart from the airfoil in a stacked orientation; and
a second air knife fluidly coupled to the airflow generator, wherein the second air knife is operatively associated with the second airfoil.

9. The lift generating system of claim 6, wherein the enclosure is mounted to a vehicle to provide left thereto.

10. The lift generating system of claim 6, further comprising:
a second airfoil provided in the enclosure, wherein the second airfoil is spaced apart from the airfoil in a serial orientation.

11. The lift generating system of claim 10, further comprising:
one or more second airflow generators operatively associated with the inlet.
